(19) United States
(12) Patent Application Publication
(10) Pub. No.: US 2024/0037634 A1
(43) Pub. Date: Feb. 1, 2024

(54) STORE TABLE DEVICE FOR PROVIDING STORE INFORMATION AND COLLECTING CUSTOMER INFORMATION

(71) Applicant: HELLO FACTORY CO., LTD., Seoul (KR)

(72) Inventor: Kyungmin KIM, Seoul (KR)

(21) Appl. No.: 17/429,267

(22) PCT Filed: Jul. 26, 2021
(86) PCT No.: PCT/KR2021/009620

§ 371 Date: Aug. 6, 2021

(30) Foreign Application Priority Data
Jul. 23, 2021 (KR) 10-2021-0097144
Jul. 23, 2021 (KR) 10-2021-0097145

(51) Int. Cl. G06Q 30/0601; G06Q 30/02

(52) U.S. Cl. CPC G06Q 30/0633; G06Q 30/0281

(57) ABSTRACT

A store table device providing store information and collecting customer information according to the present disclosure may control a communication unit to transmit request order information corresponding to an order request and table identification information of table information obtained from a table information tag to a store terminal by including the information in an order request signal upon receiving the order request from an input unit, search store information for request store information corresponding to a store information request upon receiving the store information request from the input unit, select one or more pieces of store information among the searched store information as table-tailored store information based on the table identification information, and control the display unit to display the selected table-tailored store information.

### CROSS-REFERENCE TO RELATED APPLICATIONS

This application claims the benefit under 35 U.S.C. section 371, of PCT International Application No. PCT/KR2021/009620, filed on Jul. 26, 2021, which claims foreign priority to Korean Patent Application No. 10-2021-0097144, filed on Jul. 23, 2021, and Korean Patent Application No. 10-2021-0097145, filed on Jul. 23, 2021, in the Korean Intellectual Property Office, both of which are hereby incorporated by reference in their entireties.

### BACKGROUND OF THE DISCLOSURE

### Field of the Disclosure

The present disclosure relates to a store table device providing store information and collecting customer information and, more particularly, to a store table device providing a customer within a store with information on an ordered product and store information optimized for the customer; and collecting rating information and survey information on the store, services, and products from the customer who visits the store.

### Related Art

In general, in a service place frequented by many customers, customers who want to receive service have to raise their hand or call out to the operator or employee. However, if a customer only raises his hand, the store operator or employee may not notice the customer's call. If the customer calls out to the operator or employee, it may cause inconvenience to the nearby people.

A radio paging system in a store operates for a plurality of tables where customers may sit and receive service. A wireless call button is installed on each of the plurality of tables. A user sits at the table and presses the wireless call button to call an employee and receive service. However, the user has to wait for the employee to come to the table and doesn't have a particular way of rating the employee even if he thinks the employee's service is not satisfactory.

Moreover, since a radio paging receiver in the radio paging system may receive a radio signal only at a single frequency, a radio paging transmitter that transmits a radio signal only at the frequency should be used. Therefore, if one of the radio paging transmitters and receivers goes wrong, a radio paging transmitter or receiver that transmits and receives a radio signal at the above frequency should be purchased, making maintenance difficult and inconvenient.

In addition, suppose one may not purchase a radio paging transmitter or receiver operating in pairs at the same frequency for the conventional radio paging system. In this case, they may not use the other radio paging transmitter or radio paging receiver in good condition but have to repurchase the whole radio paging system, which requires a large amount of cost.

Accordingly, the conventional radio paging system has been improved to communicate with store terminals through the wireless Internet without using a separate frequency. However, since the conventional radio paging system performs only a simple call function, the conventional radio paging system has a problem that it may not provide various types of store information.

### SUMMARY OF THE DISCLOSURE

The present disclosure provides a store table device capable of providing a customer within a store with advertisement information related with the customer, advertisement information related with time and date, and progress information on a product ordered by the customer.

Also, the present disclosure provides a store table device capable of collecting rating information and survey information on a store, a service, and a product from a customer who visits the store; and providing the customer's feedback on the store to the store manager.

Technical objects of the present disclosure are not limited to those described above. Other technical objects and advantages of the present disclosure not mentioned above may be understood from the descriptions given below and more clearly understood by the embodiments of the present disclosure. Also, it should be easily understood that the technical objects and advantages of the present disclosure may be implemented by the means described in the appended claims and a combination thereof.

To achieve the technical objects above, a store table device providing store information and collecting customer information according to the present disclosure may comprise an input unit configured to receive a request from a customer; a communication unit configured to obtain table information from a table information tag attached to a table; a display unit configured to display information to deliver the information to a customer; and a processor configured to control the communication unit to transmit request order information corresponding to an order request and table identification information included in the table information to a store terminal by including the information in an order request signal upon receiving the order request from the input unit, search the store information for request store information corresponding to a store information request upon receiving the store information request from the input unit, select one or more pieces of store information among the searched store information as table-tailored store information based on the table identification information, and control the display unit to display the selected table-tailored store information.

Preferably, when receiving an order menu request from the input unit, the processor may select one or more pieces of product information among product information as table-tailored product information based on the table identification information and control the display unit to display a product order request menu including the table-tailored product information selected.

Preferably, the processor may edit product information based on time and date information and select the table-tailored product information among the product information edited.

Preferably, after transmitting the order request signal, the processor may control the communication unit to transmit an order status request signal to the store terminal every pre-configured update time and control the display unit to display order status information received in response to the order status request signal.

Preferably, the order status information may include delivery status information indicating the delivery status of an ordered product and delivery estimated time information indicating the time required to deliver an ordered product.

Preferably, when the communication unit receives a product delivery signal indicating delivery of an ordered product, the processor may control the communication unit to calculate a waiting time ranging from the time of order at which the order request signal is transmitted to the time of delivery at which the product delivery signal is received and to transmit the calculated waiting time to the store terminal.

Preferably, the processor may control the display unit to display one or more of a service rating request menu and an order rating request menu upon receiving a rating menu request from the input unit and control the communication unit to transmit request rating information corresponding to the rating request and table identification information included in the table information to a store terminal by including the information in a rating request signal upon receiving a rating request from the input unit.

Preferably, the processor may control the display unit to display the service rating request menu including request service information corresponding to a service request received previously from a customer.

Preferably, the processor may control the display unit to display one or more of the order rating request menus including request order information corresponding to an order request received previously from a customer.

Preferably, the processor may control the display unit to display an authentication code including access information of a customer authentication page that performs customer authentication.

Preferably, the authentication code may include table information obtained from the table information tag attached to the table.

Preferably, when receiving an order request from the input unit, the processor may generate benefit information based on the request order information corresponding to the order request and control the display unit to display an additional benefit code by matching the benefit information to customer information.

Preferably, the benefit code may include information on the amount of accrued benefits due to the request order information and table information obtained from the table information tag attached to the table.

Preferably, when the communication unit receives customer delivery information or customer notification that a store employee wants to deliver to a customer, the processor may control the display unit to display the customer delivery information or the customer notification.

A store table device providing store information and collecting customer information according to the present disclosure may further comprise a vibration unit that outputs notification vibration corresponding to the customer delivery information or the customer notification.

### BRIEF DESCRIPTION OF THE DRAWINGS

FIG. 1 illustrates a situation in which a store table device providing store information and collecting customer information communicates with other constituting elements according to various embodiments of the present disclosure.

FIG. 2 is a block diagram showing constituting elements of a store table device providing store information and collecting customer information according to one embodiment of the present disclosure.

FIG. 3 illustrates communication performed between a store table device providing store information and collecting customer information and a table information tag according to one embodiment of the present disclosure.

FIG. 4 illustrates input means of an input unit included in a store table device providing store information and collecting customer information according to one embodiment of the present disclosure.

FIG. 5 illustrates a service menu displayed by a display unit included in a store table device providing store information and collecting customer information according to various embodiments of the present disclosure.

FIG. 6 illustrates a store information menu displayed by a display unit included in a store table device providing store information and collecting customer information according to various embodiments of the present disclosure.

FIG. 7 illustrates an order menu displayed by a display unit included in a store table device providing store information and collecting customer information according to various embodiments of the present disclosure.

FIG. 8 illustrates an order status information displayed by a display unit included in a store table device providing store information and collecting customer information according to various embodiments of the present disclosure.

FIG. 9 illustrates a payment menu displayed by a display unit included in a store table device providing store information and collecting customer information according to various embodiments of the present disclosure.

FIG. 10 illustrates a rating menu displayed by a display unit included in a store table device providing store information and collecting customer information according to various embodiments of the present disclosure.

FIG. 11 illustrates an authentication code and a benefit code displayed by a display unit included in a store table device providing store information and collecting customer information according to various embodiments of the present disclosure.

### DESCRIPTION OF EXEMPLARY EMBODIMENTS

A store table device providing store information and collecting customer information according to the present disclosure may control a communication unit to transmit request order information corresponding to an order request and table identification information of table information obtained from a table information tag to a store terminal by including the information in an order request signal upon receiving the order request from an input unit, search the store information for request store information corresponding to a store information request upon receiving the store information request from the input unit, select one or more pieces of store information among the searched store information as table-tailored store information based on the table identification information, and control the display unit to display the selected table-tailored store information.

In what follows, various embodiments of the present disclosure will be described with reference to appended drawings. However, it should be understood that the specific embodiments are not intended to limit the gist of the present disclosure to the specific embodiments; rather, it should be understood that the specific embodiments include all of the modifications, equivalents, and/or alternatives of the embodiments of the present disclosure. Regarding the description of the drawings, similar constituting elements are given similar reference symbol numbers.

In the present disclosure, expressions like “have,” “may have,” “include,” or “may include” indicates the existence of the corresponding feature (for example, constituting elements such as a numerical value, a function, an operation, or a component) and does not exclude the existence of an additional feature.

In the present disclosure, expressions like “A or B,” “at least one of A and/or B,” or “one or more of A and/or B” may include all possible combinations of the items listed together. For example, “A or B,” “at least one of A and B,” or “at least one of A or B” may indicate all of the cases (1) including at least one A, (2) including at least one B, or (3) including at least one A and at least one B.

The expression of “first” or “second” used in the present disclosure may modify various constituting elements irrespective of their order and/or importance. The term is used only to distinguish one from other constituting elements but does not limit the corresponding constituting elements. For example, the first user device and the second user device may represent different user devices irrespective of their order or importance. For example, without leaving the technical scope of the present disclosure defined by the appended claims, a first constituting element may be called a second constituting element, and similarly, the second element may be called the first element.

If a constituting element (for example, a first constituting element) is said to be “(operatively or communicatively) coupled with/to” or “connected to” to other constituting element (for example, a second constituting element), it should be understood that the former may be coupled directly to the other constituting element, or another constituting element (for example, a third constituting element) is present between the two constituting elements. On the other hand, if a constituting element (for example, the first constituting element) is said to be “directly coupled to” or “directly connected to” other constituting element (for example, the second constituting element), it should be understood that there is no other constituting element (for example, the third constituting element) between the two constituting elements.

The expression “configured to (or set up to)” used in the present disclosure may be interchangeable with “suitable for,” “having the capacity to,” “designed to,” “adapted to,” “made to,” or “capable of” depending on the context. The term “configured to (or set up to)” may not necessarily mean only the hardware term of “specifically designed to.” Instead, in some contexts, the expression “a device configured to do something” may mean that the device is “capable of doing something” with other devices or parts. For example, the phrase “a processor configured (or set up) to perform A, B, and C” refers to a general-purpose processor (for example, CPU or application processor) capable of performing the corresponding operation by running a processor (for example, an embedded processor) dedicated for performing the corresponding operation or one or more software programs stored in a memory.

Terms used in the present disclosure are intended only for describing a specific embodiment and are not intended to limit the technical scope of other embodiments. A singular expression should be understood to indicate a plural expression unless otherwise explicitly stated according to a particular context. Terms used in the present disclosure, including technical or scientific terms, may convey the same meaning as understood generally by those skilled in the art to which the present disclosure belongs. Among the terms used in the present disclosure, those defined in ordinary dictionaries should be interpreted to have the same or similar meaning conveyed by a related technology in the corresponding context. And unless otherwise defined explicitly in the present disclosure, those terms should not be interpreted to have ideal or excessively formal meaning. Depending on situations, even the terms defined in the present disclosure may not be construed to exclude the embodiments of the present disclosure.

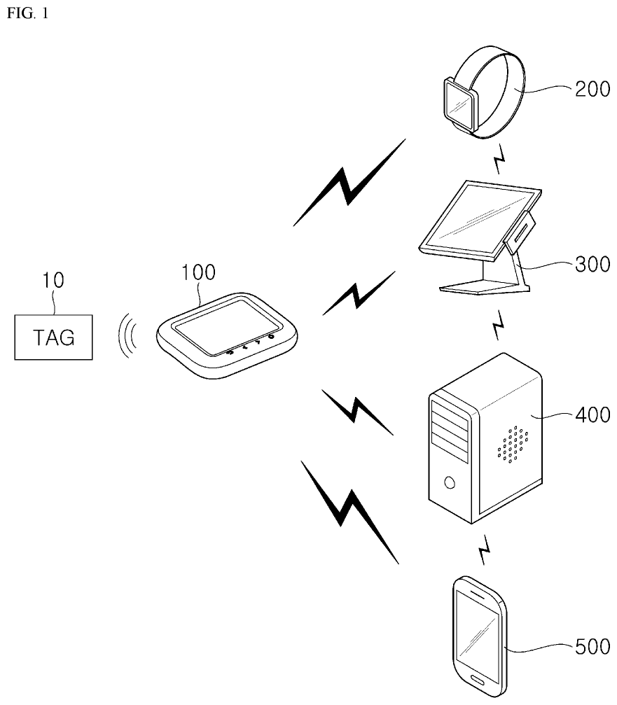

FIG. 1 illustrates a situation in which a store table device 100 providing store information and collecting customer information communicates with other constituting elements according to various embodiments of the present disclosure.

Referring to FIG. 1, a store table device 100 providing store information and colleting customer information may transmit and receive information by performing communication with an employee terminal 200, a store terminal 300, a server 400, and a user terminal 500, respectively.

The store table device 100 providing store information and collecting customer information may refer to all kinds of devices located within a place providing a service to a customer and delivering a request from the customer to a service provider or processing the request.

Specifically, the store table device 100 providing store information and collecting customer information may be placed on each table in a store and transmit a service request signal to one or more of the store employee 200, the store terminal 300, and the server 400 to call a service provider in response to the customer's request.

Also, the store table device 100 providing store information and collecting customer information may transmit an order request signal to one or more of the store employee 200, the store terminal 300, and the server 400 to deliver an order requested by a customer to a service provider.

The store table device 100 providing store information and collecting customer information may be used in various places providing services, such as restaurants, karaoke bars, pubs, screen golf courses, and bowling alleys, and the device's application range is not limited to the above.

The employee terminal 200 may be a device operated by each employee working for the store. For example, the employee terminal 200 may be a smartwatch.

The employee terminal 200 may receive and display a service request signal from the store table device 100 providing store information and collecting customer information, thereby informing the employee that a customer has requested service.

The store terminal 300 may be a device located in a store and operated by an employee or a store operator. For example, the store terminal 300 may be a POS device.

The store terminal 300 may receive a service request signal from the store table device 100 providing store information and collecting customer information and transmit the received service request signal to the employee terminal 200. Also, the store terminal 300 may receive an order request signal from the store table device 100 providing store information and collecting customer information and accept the requested order.

The server 400 may refer to all kinds of devices that receive and process information from the store table device 100 providing store information and collecting customer information.

Also, the server 400 may store and manage store operation information generated during the process of store operation by transmitting and receiving information through communication with the employee terminal 200, the store terminal 300, and the user terminal 500.

Here, the store operation information may represent service requests, orders, and sales in the store.

The customer terminal 500 may be a device operated by the customer visiting the store. For example, the customer terminal 500 may be a mobile device.

The customer terminal 500 may pay for a product that the customer has ordered by performing communication with the store table device 100 providing store information and collecting customer information.

At this time, the customer terminal 500 may pay for a product that the customer has ordered by performing Near Field Communication (NFC) with the store table device 100 providing store information and collecting customer information or by recognizing an electronic code displayed on the store table device 100 providing store information or collecting customer information. Here, the electronic code may be the Quick Response (QR) code.

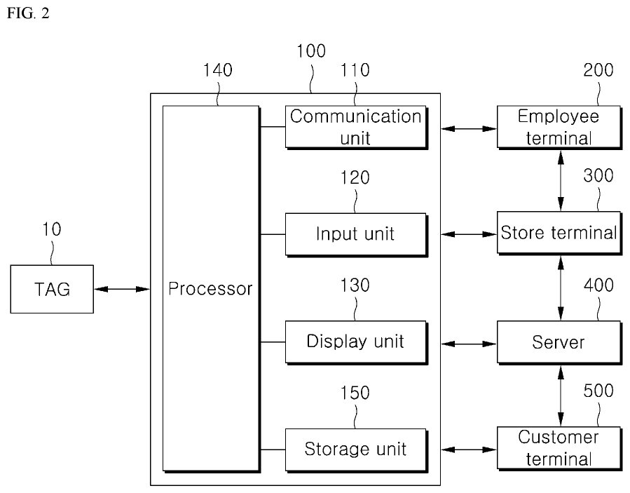

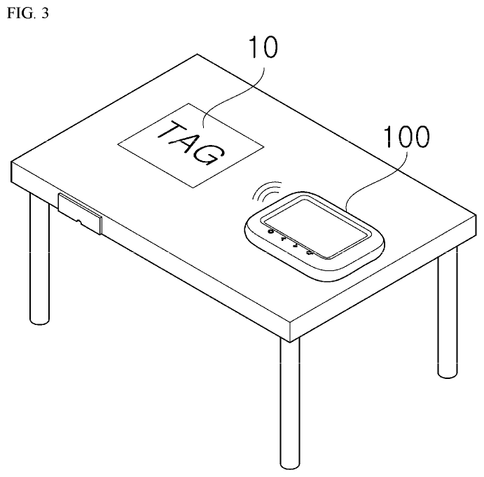

FIG. 2 is a block diagram showing constituting elements of a store table device 100 providing store information and collecting customer information according to one embodiment of the present disclosure, and FIG. 3 illustrates communication performed between a store table device 100 providing store information and collecting customer information and a table information tag 10 according to one embodiment of the present disclosure.

Referring further to FIGS. 2 and 3, the store table device providing store information and collecting customer information may include a communication unit 110, an input unit 120, a display unit 130, a processor 140, and a storage unit 150.

The communication unit 110 may perform communication with a table information tag 10, an employee terminal 200, a store terminal 300, a server 400, and a user terminal 500.

Specifically, the communication unit 110 may perform short-range wireless communication with the table information tag 10 and perform general-purpose wireless communication with the employee terminal 200, the store terminal 300, the server 400, and the user terminal 500.

Here, short-range wireless communication may be NFC communication, and to this purpose, the communication unit 110 may be equipped with an NFC module. Also, general-purpose wireless communication may use the Internet or a cellular communication protocol based on one of Wireless Fidelity (WiFi), Bluetooth, Long-Term Evolution (LTE), LTE

Advanced (LTE-A), Code Division Multiple Access (CDMA), Wideband CDMA (WCDMA), Universal Mobile Telecommunications System (UMTS), Wireless Broadband (WiBro), and Global System for Mobile Communications (GSM). To this purpose, the communication unit 110 may be equipped with various general-purpose wireless communication modules, including a WiFi module, a Bluetooth module, and an LTE module.

As shown in FIG. 3, when the communication unit 110 is separated from the table information tag 10 within a range that allows short-range wireless communication with the table information tag 10, the communication unit 110 may receive table information by performing short-range wireless communication with the table information tag 10. Here, the table information may include one or more of table identification information of a table to which the table information tag 10 is attached and store identification information of a store in which the table information tag 10 is located. Meanwhile, the table information tag 10 may be an NFC tag storing the table information.

Meanwhile, the communication unit 110 may transmit a service request signal and an order request signal to one or more of the employee terminal 200, the store terminal 300, and the server 400 according to the control of the processor 140.

The communication unit 110 according to another embodiment may transmit device status information generated by the processor 140 to one or more of the employee terminal 200, the store terminal 300, and the server 400.

Also, the communication unit 110 according to another embodiment may receive customer delivery information or customer notification that a store employee wants to deliver to the customer from one or more of the employee terminal 200, the store terminal 300, and the server 400.

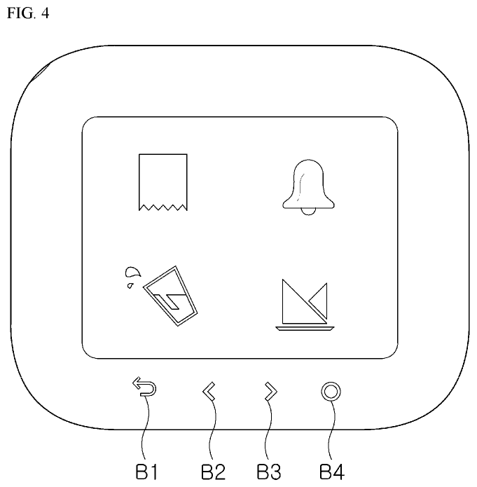

FIG. 4 illustrates input means of an input unit 120 included in a store table device 100 providing store information and collecting customer information according to one embodiment of the present disclosure.

Referring further to FIG. 4, the input unit 120 may receive various requests from a customer.

Specifically, the input unit 120 may receive a button selection from the customer.

As shown in FIG. 4, the input unit 120 may receive a push input on the movement buttons B1, B2, B3 from the customer. When a push input is applied on the menu movement buttons B1, B2, B3, the processor 140 may determine that the customer has input a menu change request and controls the display unit 130 to change the information displayed on the display unit 130 or change the selection state information of a menu displayed on the display unit 130.

Meanwhile, the input unit 120 may receive a push input on the menu selection button B4 from the customer. When a push input is applied to the menu movement buttons B1, B2, B3, the processor 140 may determine that the corresponding request and information have been selectively input to a menu currently in a selection state, determine that a request for displaying a menu and information corresponding to the selectively input request and information has been selectively input, and control the display unit 130 to display the information corresponding to the selectively input menu and information.

The input unit 120 may receive a service menu request, a service request, a store information menu request, a store information request, an order menu request, an order request, a payment menu request, a payment request, a rating menu request, and a rating request.

The display unit 130 may be composed of a color liquid crystal including a Liquid Crystal Display (LCD). However, depending on the embodiments, the display unit 130 may be made of E-paper or a high-resolution circular screen that may be driven with low power but is not limited to the example above.

Specifically, the display unit 130 may be implemented using various types of display panels. For example, the display panel may be implemented from various display technologies, including Liquid Crystal Display (LCD), Organic Light-Emitting Diodes (OLED), Active-Matrix Organic Light-Emitting Diode (AM-OLED), Liquid Crystal on Silicon (LCoS), Digital Light Processing (DLP), and Electronic Paper Display (EPD).

In addition, the display unit 130 may be coupled to at least one of a front area, a side area, and a rear area of the store table device 100 providing store information and collecting customer information in the form of a flexible display. The flexible display may be characterized in that it may be bent, curved, or rolled without being damaged through a thin and flexible substrate like paper. The flexible display may be manufactured using a plastic substrate as well as a glass substrate used in common. When a plastic substrate is used, to prevent the substrate from being damaged, the flexible display may be formed using a low-temperature manufacturing process instead of employing the conventional manufacturing process. In addition, by replacing the glass substrate covering the flexible liquid crystal with a plastic film, it is possible to impart flexibility of folding and unfolding to the flexible display. The flexible display has the advantage of being thin and light and resisting impact, and being bent or curved to be manufactured in various shapes.

The display unit 130 may display various pieces of information related to the customer's request and display various menus for receiving the customer's request.

When the communication unit 110 receives customer delivery information or customer notification that a store employee wants to deliver to the customer from one or more of the employee terminal 200, the store terminal 300, and the server 400, the display unit 130 according to another embodiment may display the received customer delivery information or customer notification.

To this purpose, the display unit 130 may operate according to an input to the input unit 120 and control of the processor 140 according to the information received by the communication unit 110.

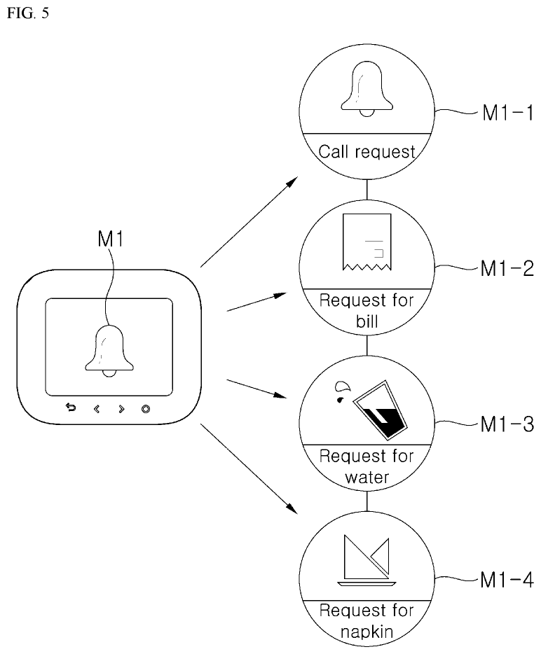

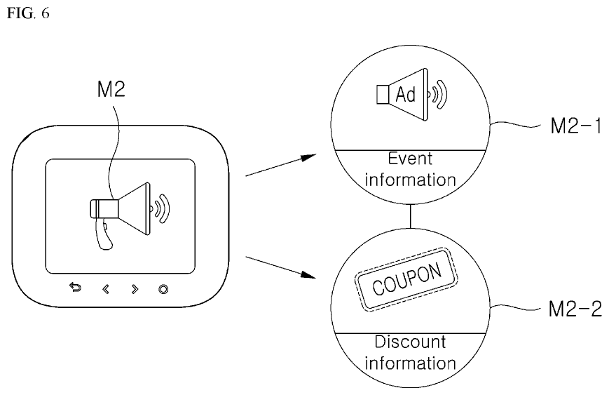

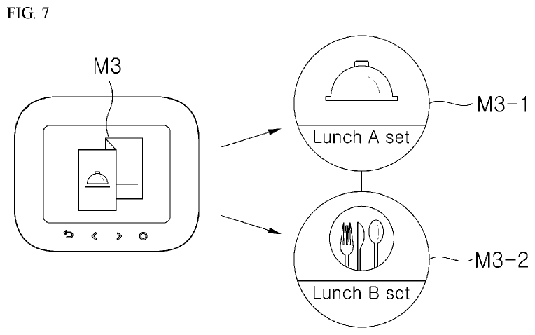

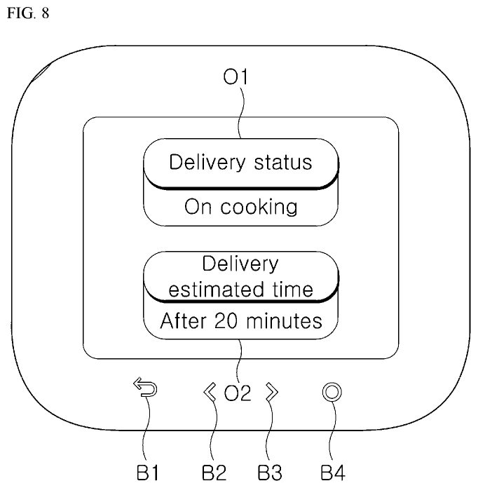

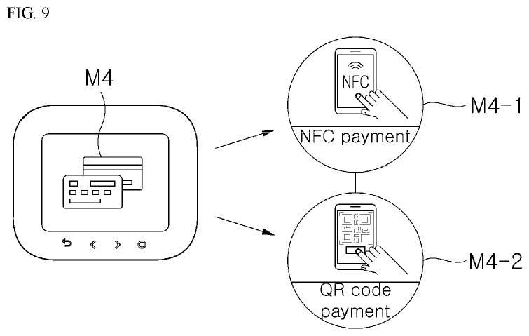

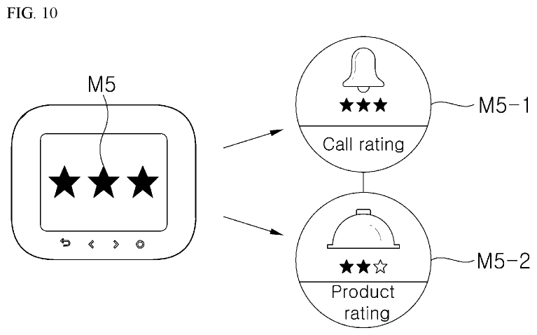

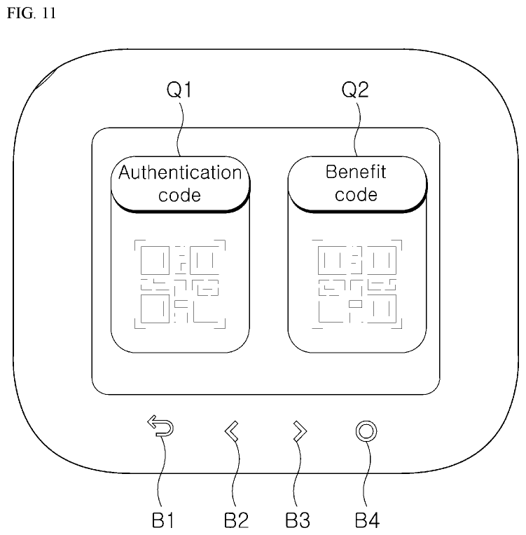

FIG. 5 illustrates a service menu M1 displayed by a display unit 130 included in a store table device 100 providing store information and collecting customer information according to various embodiments of the present disclosure; FIG. 6 illustrates a store information menu M2 displayed by a display unit 130 included in a store table device 100 providing store information and collecting customer information according to various embodiments of the present disclosure; FIG. 7 illustrates an order menu M3 displayed by a display unit 130 included in a store table device 100 providing store information and collecting customer information according to various embodiments of the present disclosure; FIG. 8 illustrates an order status information O1, O2 displayed by a display unit 130 included in a store table device 100 providing store information and collecting customer information according to various embodiments of the present disclosure; FIG. 9 illustrates a payment menu M4 displayed by a display unit 130 included in a store table device 100 providing store information and collecting customer information according to various embodiments of the present disclosure; FIG. 10 illustrates a rating menu M5 displayed by a display unit 130 included in a store table device 100 providing store information and collecting customer information according to various embodiments of the present disclosure; and FIG. 11 illustrates an authentication code Q1 and a benefit code Q2 displayed by a display unit 130 included in a store table device 100 providing store information and collecting customer information according to various embodiments of the present disclosure.

Referring further to FIGS. 5 to 11, the processor 140 may control the display unit 130 to display a menu according to a customer's input to the input unit 120.

Specifically, when the input unit 120 receives a rotation input from the customer, the processor 140 may control the display unit 130 to display a service menu M1, a store information menu M2, an order menu M3, a payment menu M4, and a rating menu M5 one by one sequentially.

When the input unit 120 receives a button selection input while one of the service menu M1, the store information menu M2, the order menu M3, the payment menu M4, and the rating meu M5 is displayed, the processor 140 may control the display unit 130 to display a sub-menu of the corresponding menu.

Specifically, as shown in FIG. 5, when the input unit 120 receives a button selection input while the display unit 130 is displaying the service menu M1, the processor 140 may determine that a service menu request has been input and control the display unit 130 to display one of a call service request menu M1-1, a bill delivery service request menu M1-2, a water delivery service request menu M1-3, and a napkin delivery service request menu M1-4.

Afterward, when the input unit 120 receives a button selection input while the display unit 130 is displaying one of the call service request menu M1-1, the bill delivery service request menu M1-2, the water delivery service request menu M1-3, and the napkin delivery service request menu M1-4, the processor 140 may determine that a service request corresponding to the displayed service request menu M1-1, . . . , M1-4 has been input.

For example, when a button selection is input to the input unit 120 while the call service request menu M1-1 is displayed on the display unit 130, the processor 140 may determine that a call service request has been input. Also, when a button selection is input to the input unit 120 while the bill delivery service request menu M1-2 is displayed on the display unit 130, the processor 140 may determine that a bill delivery service request has been input. Also, when a button selection is input to the input unit 120 while the water delivery service request menu M1-3 is displayed on the display unit 130, the processor 140 may determine that a water delivery service request has been input. Also, when a button selection is input to the input unit 120 while the napkin delivery service request menu M1-4 is displayed on the display unit 130, the processor 140 may determine that a napkin delivery service request has been input.

Here, the call service request may mean a customer's request of calling an employee or a store operator who provides a service to the customer's table. The bill delivery service request may mean that the customer wants the employee or the store operator who provides a service to deliver a bill to the customer's table. The water delivery service request may mean that the customer wants the employee or the store operator who provides a service to deliver water to the customer's table. The napkin delivery service request may mean that the customer wants the employee or the store operator who provides a service to deliver the napkin to the customer's table.

The service request above indicates a call, a request for delivery of a bill, delivery of water, and delivery of napkin. However, it should be noted that the object type is not limited to the example above.

Meanwhile, when a service request is received, the processor 140 may control the communication unit 110 to transmit request service information corresponding to the service request and table identification information included in the table information to the employee terminal by including the information in a service request signal.

Here, the request service information may indicate which service request the customer has input. For example, when the customer inputs a call service request, the request service information may represent a call service. Through this operation, when the request service information is delivered to the employee terminal 200 by being included in a service request signal, the employee may be informed of the service requested by the customer.

Specifically, when a service request is received, the processor 140 may check whether table information has been obtained. If the table information has been obtained, the processor 140 may check the table identification information included in the table information.

On the other hand, if the table information has not been obtained, the processor 140 may control the display unit 130 to display tagging guide information that guides tagging between the store table device 100 providing store information and collecting customer information and the table information tag 10 and control the communication unit 110 to obtain the table information from the table information tag 10.

Meanwhile, the processor 140 may confirm the checked table identification information and mapped employee terminal identification information and control the communication unit 110 to transmit a service request signal including the request service information and the table identification information to the employee terminal 200 corresponding to the confirmed employee terminal identification information.

Here, the processor 140 may check the employee terminal identification information mapped to the table identification information by referring to the table-employee mapping information.

Meanwhile, when a service request is received, the processor 140 according to another embodiment may check the table position information mapped to the table identification information and control the communication unit 110 to transmit a service request signal to the employee terminal 200 located within a pre-configured transmission range from the table position indicated by the table position information.

Specifically, the processor 140 according to another embodiment may check the table identification information and the mapped table position information by referring to the table-position mapping information, set an area within the pre-configured transmission range as a transmission area based on the table position indicated by the checked table position information, and control the communication unit 110 to transmit a service request signal to the employee terminal 200 corresponding to the employee terminal position located with the transmission area among employee terminal positions indicated by each employee terminal position information received by the communication unit 110 from a plurality of employee terminals 200 located within a store.

Through the operation above, the processor 140 according to another embodiment may request a service from both a customer who requests the service and an employee in the customer's vicinity, thereby making the requested service processed quickly.

Meanwhile, as shown in FIG. 6, when the input unit 120 receives a button selection input while the display unit 130 is displaying the store information menu M2, the processor 140 may determine that a store information menu request has been input and control the display unit 130 to display one of an event information request menu M2-1 and a discount information request menu M2-2.

At this time, when the input unit 120 receives a rotation input from the customer, the processor 140 may control the display unit 130 to display the event information request menu M2-1 and the discount information request menu M2-2 one by one sequentially.

Afterward, when the input unit 120 receives a button selection input while one of the event information request menu M2-1 and the discount information request menu M2-2 is displayed, the processor 140 may determine that a store information request corresponding to the displayed information request menu M2-1, M2-2 has been input.

For example, when a button selection is input to the input unit 120 while the event information request menu M2-1 is displayed on the display unit 130, the processor 140 may determine that an event information request has been input. Also, when a button selection is input to the input unit 120 while the discount information request menu M2-2 is displayed on the display unit 130, the processor 140 may determine that a discount information request has been input.

Here, the store information request may be a request for information on the store. Specifically, the event information request may mean a request for information on an event currently going on in the store, and the discount information request may mean a request for information on a discount currently provided in the store. Also, the store information request may mean a request for information on store notifications and store advertisement in addition to the event information and the discount information.

Meanwhile, when a store information request is received, the processor 140 may search the store information for the requested store information corresponding to the store information request, select one or more store information among the searched store information as table-tailored store information based on the table identification information, and control the display unit 130 to display the selected table-tailored store information.

Here, the requested store information may represent a store information request input by the customer. For example, when the customer inputs a discount information request as a store information request, the requested stored information may represent discount information.

Here, the store information may be stored in the storage unit 150. The processor 140 may control the communication unit 110 to transmit a store information update request signal that requests the most recent store information to the server 400 every pre-configured update period and when the store information is received from the communication unit 110 in response to the store information update request signal, update the store information stored in the storage unit 150 with the store information received from the communication unit 110.

Through the operation above, the processor 140 may search for the information corresponding to the request store information representing the store information requested by the customer among the event information and the discount information included in the store information.

The processor 140 may check the table capacity information corresponding to the table identification information by referring to the table-capacity mapping information that maps the table identification information to the table capacity information and may select one of the searched store information as table-tailored store information based on the checked table capacity information.

For example, when a discount information request is received and the table capacity information mapped to the table identification information indicates 4, the processor 140 may search the store information for the discount information and select only the discount information applicable to four people among the discount information as the table-tailored store information.

Afterward, the processor 140 may control the display unit 130 to display the selected table-tailored store information.

Through the operation, the processor 140 may provide only the store information suitable for a customer considering a table occupied by the customer rather than providing all of the store information to the customer who has requested store information.

Meanwhile, as shown in FIG. 7, when the input unit 120 receives a button selection input while the display unit 130 is displaying the order menu M3, the processor 140 may determine that an order menu request has been input, select one or more product information as table-tailored product information among the product information based on the table identification information, and control the display unit 130 to display a product order request menu including the selected table-tailored product information.

Specifically, the processor 140 may check the table capacity information corresponding to the table identification information by referring to the table-capacity mapping information that maps the table identification information to the table capacity information and may select one from among the product information representing the products sold in the store based on the table capacity information.

For example, when an order menu request is received and the table capacity information mapped to the table identification information indicates 4, the processor 140 may select, among the product information, the product information that may be provided to four people as the table-tailored product information.

Through the operation, the processor 140 may display, on the display unit, only the product information representing the products that may be provided to a customer considering a table occupied by the customer by including the product information in a product order request menu, rather than displaying, on the display unit 130, the product information of all products sold in the store by including the product information in the product order request menu for the customer who has requested an order menu.

Meanwhile, the processor 140 may edit the product information based on the time and date information and select table-tailored product information among the product information edited.

Through the operation, the processor 140 may increase the store's sales by recommending products suitable for customers.

In what follows, a case where two pieces of table-tailored product information are selected will be described.

When the first table-tailored product information and the second table-tailored product information are selected as table-tailored product information, the processor 140 may control the display unit 130 to display one of the first product order request menu M3-1 including the first table-tailored product information and the second product order request menu M3-2 including the first table-tailored product information.

At this time, when the input unit 120 receives a rotation input from the customer, the processor 140 may control the display unit 130 to display the first product order request menu M3-1 and the second product order request menu M3-2 one by one sequentially.

Afterward, when a button selection is input to the input unit 120 while one of the first product order request menu M3-1 and the second product order request menu M3-2 is displayed on the display unit 130, the processor 140 may determine that an order request corresponding to the displayed product order request menu M3-1, M3-2 has been ordered.

For example, when a button selection is input to the input unit 120 while the first product order request menu M3-1 is displayed on the display unit 130, the processor 140 may determine that a first product order request that orders a product corresponding to the first table-tailored product information has been input. Also, when a button selection is input to the input unit 120 while the second product order request menu M3-2 is displayed on the display unit 130, the processor 140 may determine that a second product order request that orders a product corresponding to the second table-tailored product information has been input.

Here, the order request may be a product order request for a product sold in the store.

Meanwhile, when an order request is input, the processor 140 may control the communication unit 110 to transmit request order information corresponding to the order request and the table identification information to the store terminal 300 by including the information in an order request signal.

Here, the request order information may represent an ordered product indicated by an order request input from the customer.

After transmitting an order request signal, the processor 140 may control the communication unit 110 to transmit an order status request signal to the store terminal every pre-configured update time and as shown in FIG. 8, control the display unit 130 to display the received order status information O1, O2 in response to the order status request signal.

Here, the order status information may include delivery status information O1 representing the delivery status of an ordered product and delivery estimated time information O2 representing the time required until delivery of the ordered product.

Meanwhile, when the communication unit 110 receives a product delivery signal indicating that an ordered product is ready, the processor 140 may control the communication unit 110 to calculate a waiting time from the time of order at which an order request signal is transmitted to the time of delivery at which a product delivery signal is received and transmit the calculated waiting time to the store terminal 300.

Through the operation above, the store manager may efficiently manage the delivery of ordered products.

Meanwhile, as shown in FIG. 9, when the input unit 120 receives a button selection input while the display unit 130 is displaying a payment menu M4, the processor 140 may determine that a payment menu input has been input and control the display unit 130 to display one of the NFC payment request menu M4-1 and the QR code payment request menu M4-2.

At this time, when the input unit 120 receives a rotation input from the customer, the processor 140 may control the display unit 130 to display the NFC payment request menu M4-1 and the QR code payment request menu M4-2 one by one sequentially.

Afterward, when a button selection is input to the input unit 120 while one of the NFC payment request menu M4-1 and the QR code payment request menu M4-2 is displayed on the display unit 130, the processor 140 may determine that a payment request corresponding to the displayed payment request menu M4-1, . . . , M4-4 has been input.

For example, when a button selection is input to the input unit 120 while the NFC payment request menu M4-1 is displayed on the display unit 130, the processor 140 may determine that an NFC payment request has been input. Also, when a button selection is input to the input unit 120 while the QR code payment request menu M4-2 is displayed on the display unit 130, the processor 140 may determine that a QR code payment request has been input.

Here, the NFC payment request may mean that payment is to be performed using NFC communication between the customer terminal 500 that has requested payment and the store table device 100 collecting customer information. When the NFC payment request is input, the processor 140 may control the display unit 130 to display tagging guide information that guides tagging between the store table device 100 providing store information and collecting customer information and the customer terminal 500. The processor 140 may complete the payment for a product that the customer has ordered by transmitting the payment information obtained through NFC payment to the server 400.

The QR code payment request may mean that the customer terminal 500 performs payment by recognizing a QR code. The processor 140 may generate a QR code for payment and control the display unit 130 to display the generated QR code. And the processor 140 may control the display unit 130 to display QR code recognition information that guides the customer terminal 500 to recognize the QR code. The customer terminal 500 may complete the payment for a product ordered by the customer at a payment page accessed through QR code recognition.

Meanwhile, as shown in FIG. 10, when the input unit 120 receives a button selection input while the display unit 130 is displaying a rating menu M5, the processor 140 may determine that a rating menu request has been input and control the display unit 130 to display one of a service rating request menu M5-1 including request service information corresponding to a service request input previously and an order rating request menu M5-2 including request order information corresponding to an order request input previously.

For example, when a service request input previously is a call service request, the processor 140 may control the display unit 130 to display a service rating request menu M5-1 including request service information representing a call service.

Also, when an order request input previously is a first product order request, the processor 140 may control the display unit 130 to display an order rating request menu M5-2 including request order information representing the first product ordered previously.

Through the operation, a customer may check a request service and a request order requested previously and prepared for rating.

At this time, when the input unit 120 receives a rotation input from the customer, the processor 140 may control the display unit 130 to display the service rating request menu M5-1 and the order rating request menu M5-2 one by one sequentially.

Afterward, when a button selection is input to the input unit 120 while one of the service rating request menu M5-1 and the order rating request menu M5-2 is displayed on the display unit 130, the processor 140 may control the display unit 130 to display a rating information input area through which request rating information may be input.

Here, the rating information input area may be an area through which request rating information may be input from a customer. For example, when the rating information input area is activated, a star image representing request rating information may be displayed.

When the input unit 120 receives a rotation input from the customer while one of rating information input areas between the service rating request menu M5-1 and the order rating request menu M5-2 is activated and displayed, the processor 140 may control the display unit 130 to display an image representing request rating information on the rating information input area.

For example, in the rating information input area, the number of star images may be increased or decreased to be displayed according to the rotation input to the input unit 120.

When the input unit 120 receives a button selection while the rating information input area is displaying an image representing request rating information, the processor 140 may determine that a rating request has been input and control the communication unit 110 to transmit the request rating information corresponding to the rating request and the table identification information to the store terminal 300 by including the information in a rating request signal.

Through the operation above, the customer may input a rating on the service and the order requested by the customer and handled accordingly to the store table device 100 providing store information and collecting customer information.

Meanwhile, the processor 140 according to another embodiment may check the device status and generate device status information. Here, the device status information may include one or more of the battery status information, communication status information, and operation temperature information of the store table device 100 providing store information and collecting customer information.

Meanwhile, as shown in FIG. 11, the processor 140 may control the display unit 130 to display an authentication code Q1 that includes access information of a customer authentication page for performing customer authentication.

Here, the authentication code Q1 may include table information obtained from a table information tag attached to the table.

In other words, the user terminal 500 may recognize the authentication code Q1 and perform customer authentication by accessing a customer authentication page for customer authentication.

Through the customer authentication, advertisement information optimized for the customer may be provided.

When an order request is received from the input unit 120, the processor 140 may generate benefit information based on the request order information corresponding to an order request and control the display unit 130 to display an additional benefit code Q2 by matching the benefit information to the customer information.

Here, the benefit code may include information on the amount of accrued benefits due to the request order information and table information obtained from the table information tag attached to the table.

In other words, the user terminal 500 may recognize the benefit code Q2 and store the benefits provided in a store by matching the benefits to the customer information.

Through the operation, benefits due to an ordered product may be provided to a customer who has ordered the product in the store.

Meanwhile, the processor 140 may control the communication unit 110 to receive, from the store terminal 300 or the server 400, store congestion information indicating the ratio of the maximum number of orders accommodated to the number of current orders in the store.

Afterward, when a product that a customer has ordered is delivered, the processor 140 may determine whether congestion information exceeds reference congestion and if the congestion information exceeds the reference congestion, control the display unit 130 to display reception request information that requests the customer to receive the product.

When the customer receives the product in response to the reception request information, the processor 140 may generate benefit information and control the display unit 130 to display an additional benefit code Q2 by matching the benefit information to the customer information.

Through the operation above, when the number of employees lacks due to increased orders, employees' workload may be reduced by requesting customers to receive their ordered product and providing benefits to those who receive their product themselves.

Meanwhile, the processor 140 may control the operation of the communication unit 110, the input unit 120, the display unit 130, and the storage unit 150.

The processor 140 may include a connection path (for example, bus) through which signals are transmitted and received to and from one or more cores (not shown), a graphic processing unit (not shown), and/or other constituting elements.

The processor 140 according to one embodiment may be configured to operate the store table device 100 providing store information and collecting customer information by executing one or more instructions stored in the storage unit 150.

The storage unit 150 may store programs (one or more instructions) for processing and controlling the processor 140. The programs stored in the storage unit 150 may be divided into a plurality of modules according to their function.

The storage unit 150 may be composed of RAMs and ROMs.

The RAM stores O/S and application programs. Specifically, when the store table device 100 providing store information and collecting customer information boots up, the RAM stores O/S and various application data selected by the user.

The ROM stores instruction sets required for system booting. When a turn-on instruction is received, and power is supplied, the processor 140 copies the O/S into the RAM according to the instructions stored in the ROM and boots up the system by executing the O/S. When the boot sequence is completed, the processor copies various application programs into the RAM and performs various operations by running the application programs copied into the RAM.

Meanwhile, the store table device 100 providing store information and collecting customer information according to another embodiment may further include a vibration unit (not shown).

The vibration unit may output vibration in response to the customer delivery information or customer notification received by the communication unit 110 from one or more of the employee terminal 200, the store terminal 300, and the server 400. The vibration unit may inform the customer of the customer notification information through vibration according to the operation above.

So far, the present disclosure has been described with reference to the preferred embodiments thereof. It should be understood by those skilled in the art to which the present disclosure belongs that the present disclosure may be implemented in various other modified forms without deviating from the inherent characteristics of the present disclosure. In this respect, the disclosed embodiments should be considered in a descriptive point of view rather than restrictive point of view. The technical scope of the present disclosure should be judged by the appended claims rather than the descriptions given above, and all of the discrepancies which may be found within the range equivalent to the technical scope of the present disclosure should be interpreted to belong thereto.

As described above, although the present disclosure has been described with reference to a limited number of embodiments and drawings, the present disclosure is not limited by the descriptions; rather, it should be understood by those skilled in the art to which the present disclosure belongs that various modifications and changes may be made within the technical principles and equivalent scope of the present disclosure defined by the appended claims.

The present disclosure may provide a customer within a store with advertisement information related with the customer, advertisement information related with time and date, and progress information on a product ordered by the customer, thereby increasing sales of the store and providing feedback on the ordered product to the customer.

Also, the present disclosure may collect rating information and survey information on a store, a service, and a product from a customer who visits the store; and obtain information that may serve as a criterion for improving the store's services and products.

### REFERENCE NUMERALS

10: information tag
100: store table device
110: Communication unit
120: Input unit
130: Display unit
140: Processor
150: Storage unit
200: Employee terminal
300: Store terminal
400: Server
500: Customer terminal
M1-1: Call request
M1-2: Request for bill
M1-3: Request for water
M1-4: Request for napkin
M2-1: Event information
M2-2: Discount information
M3-1: Lunch A set
M3-2: Lunch B set
O1: Delivery status on cooking
O2: Delivery estimated time after 20 minutes
M4-1: NFC payment
M4-2: QR code payment
M5-1: Call rating
M5-2: Product rating
Q1: Authentication code
Q2: Benefit code

What is claimed is:

1. A store table device providing store information and collecting customer information, the device comprising:
an input unit configured to receive a request from a customer;
a communication unit configured to obtain table information from a table information tag attached to a table;
a display unit configured to display information to deliver information to a customer; and
a processor configured to
control the communication unit to transmit request order information corresponding to an order request and table identification information included in the table information to a store terminal by including the information in an order request signal upon receiving the order request from the input unit,
search store information for request store information corresponding to a store information request upon receiving the store information request from the input unit,
select one or more pieces of store information among the searched store information as table-tailored store information based on the table identification information, and
control the display unit to display the selected table-tailored store information.

2. The device of claim 1, wherein, when receiving an order menu request from the input unit, the processor selects one or more pieces of product information among product information as table-tailored product information based on the table identification information and controls the display unit to display a product order request menu including the table-tailored product information selected.

3. The device of claim 2, wherein the processor edits product information based on time and date information and selects the table-tailored product information among the product information edited.

4. The device of claim 1, wherein, after transmitting the order request signal, the processor controls the communication unit to transmit an order status request signal to the store terminal every pre-configured update time and controls the display unit to display order status information received in response to the order status request signal.

5. The device of claim 4, wherein the order status information includes delivery status information indicating delivery status of an ordered product and delivery estimated time information indicating the time required to deliver an ordered product.

6. The device of claim 1, wherein, when the communication unit receives a product delivery signal indicating delivery of an ordered product, the processor controls the communication unit to calculate a waiting time ranging from the time of order at which the order request signal is transmitted to the time of delivery at which the product delivery signal is received and to transmit the calculated waiting time to the store terminal.

7. The device of claim 1, wherein the processor controls the communication unit to transmit request rating information corresponding to the rating request and table identification information included in the table information to a store terminal by including the information in a rating request signal upon receiving a rating request from the input unit.

8. The device of claim 1, wherein the processor controls the display unit to display the service rating request menu including request service information corresponding to a service request received previously from a customer.

9. The device of claim 1, wherein the processor controls the display unit to display one or more of the order rating request menus including request order information corresponding to an order request received previously from a customer.

10. The device of claim 1, wherein the processor controls the display unit to display an authentication code including access information of a customer authentication page that performs customer authentication, wherein the authentication code includes table information obtained from the table information tag attached to the table.

11. The device of claim 1, wherein, when receiving an order request from the input unit, the processor generates benefit information based on request order information corresponding to the order request and controls the display unit to display an additional benefit code by matching the benefit information to customer information,
wherein the benefit code includes information on the amount of accrued benefits due to the request order information and table information obtained from the table information tag attached to the table.

12. The device of claim 1, wherein, when the communication unit receives customer delivery information or customer notification that a store employee wants to deliver to a customer, the processor controls the display unit to display the customer delivery information or the customer notification,
the processor further comprising a vibration unit outputting notification vibration corresponding to the customer delivery information or the customer notification.
